(19) United States
(12) Patent Application Publication
(10) Pub. No.: US 2025/0391410 A1
(43) Pub. Date: Dec. 25, 2025

(54) SYSTEMS AND METHODS FOR ENHANCING SECURITY ASSOCIATED WITH NETWORKED DEVICES VIA ARTIFICIAL INTELLIGENCE ENHANCED PROCESSING

(71) Applicant: BANK OF AMERICA CORPORATION, Charlotte, NC (US)

(72) Inventors: Sneha Padiyar, Mumbai (IN); Hariharan Balakrishnan, Chennai (IN); Maneesh Kumar Sethia, Hyderabad (IN)

(73) Assignee: BANK OF AMERICA CORPORATION, Charlotte, NC (US)

(21) Appl. No.: 18/753,509

(22) Filed: Jun. 25, 2024

(51) Int. Cl. G10L 17/18; G06F 21/31; G10L 15/22

(52) U.S. Cl. CPC G10L 17/18; G06F 21/31; G10L 15/22; G10L 2015/223

(57) ABSTRACT

Systems, computer program products, and methods are described herein for enhancing security associated with networked devices via artificial intelligence enhanced processing. The present invention may be configured to initiate data collection based on a direct user input into a data transmission device; authenticate a user based on a data transmission device onboard generative artificial intelligence analysis of the direct user input compared to at least one previous direct user input; generate a user dataset from the direct user input and from a plurality of indirect user inputs; validate or invalidate, by an AI or ML model, the direct user input based on a threat score of the user dataset if the threat score of the user dataset is above or below a required threat score threshold; and trigger a response from the data transmission device based on the validation or the invalidation of the direct user input.

### FIELD OF THE INVENTION

The present invention embraces a system for enhancing security associated with networked devices via artificial intelligence enhanced processing.

### BACKGROUND

In the current digital world, there is a focus on data transmissions through smart card voice-based interactions. However, current means of authentication security for data transmissions of this nature remain limited, and monolithic. There is a need to explore authentic methods for frictionless, intelligent network data transmission systems that utilize multifactor authentication (e.g., an authentication from a physical device, such as an authentication of a card to a person) for accurate and precise user identification. Presently, many instances of various unauthorized data transmissions go unnoticed by the user, with repeated cases and patterns being reported. Thus, there exists a need for a system, method, or computer program product that provides improvements to networked data transmission security that is automatic, dynamic, efficient, and in a secure manner.

Applicant has identified a number of deficiencies and problems associated with securing data transmissions associated with networked devices. Through applied effort, ingenuity, and innovation, many of these identified problems have been solved by developing solutions that are included in embodiments of the present disclosure, many examples of which are described in detail herein.

### SUMMARY

The following presents a simplified summary of one or more embodiments of the present invention, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

In one aspect, a system for enhancing security associated with networked devices via artificial intelligence (AI) enhanced processing discloses a system comprising: a memory device with computer-readable program code stored thereon; at least one processing device operatively coupled to the at least one memory device and the at least one communication device, wherein executing the computer-readable code is configured to cause the at least one processing device to: initiate data collection based on a direct user input into a data transmission device; authenticate a user based on a data transmission device onboard generative artificial intelligence (AI) analysis of the direct user input compared to at least one previous direct user input; generate, in response to the authentication, a user dataset from the direct user input and from a plurality of indirect user inputs to the data transmission device; validate the direct user input based on a threat score of the user dataset if the threat score of the user dataset is above a required threat score threshold or invalidate the direct user input if the threat score of the user dataset is below the required threat score threshold; and trigger a response from the data transmission device based on the validation or the invalidation of the direct user input.

In some embodiments, the authentication of the user is based on the direct user input, and the direct user input comprises a user voice command that is encrypted and compared with a plurality of stored user voice commands.

In some embodiments, the user dataset is transferred to an orchestration engine configured to: receive the user dataset from the data transmission device; request and aggregate a plurality of stored user data from a plurality of data storage locations, wherein the plurality of stored user data comprises previous direct user inputs and indirect user inputs; configure the user dataset and the plurality of stored user data for analysis in a threat analytics module; prioritize a data element from the user dataset and a data element from the plurality of stored user data to be output; transfer the data elements to a threat analytics module; and repeat the prioritization and transfer for a plurality of subsequent data elements.

In some embodiments, the threat analytics module is a cloud-based natural language application programming interface (API) for threat analytics configured to: receive an input of data from the orchestration engine; compare similar data elements from the user dataset and the plurality of stored user data; generate a match score between the compared similar data elements; and transfer the generated match scores to an AI or machine learning (ML) model.

In some embodiments, the AI or ML model is continuously trained through a federated learning strategy comprising: initializing a set of parameters for the AI or ML model through a set of initial data; continuously training the AI or ML model through analyzed data collected from a plurality of users; updating the set of parameters for the AI or ML model based on the analyzed data from a plurality of users; and obtaining a higher threat score precision via the updated set of parameters for the AI or ML model, wherein the trained AI or ML model is configured to intake the generated match scores and generate the threat score based on an assessment of the generated match scores.

In some embodiments, the data transmission device is a smart card device further comprising: the on-board generative AI; at least one built in internet of things (IoT) sensor associated with collecting user data comprising a geocoordinate, an internet protocol (IP) address, a device identifier (ID), or a user voice sample; a digital display which is configured to display a set of relevant data based on a user requested task; an alert mechanism configured to trigger an audio notification based on an invalidation of the direct user input; and at least one non-transitory memory device that stores temporary data.

In some embodiments, the at least one non-transitory memory device is a cache temporary memory device that is configured to temporarily store a plurality of user authentication data for reuse in an instance of a disruption of a user requested task.

In some embodiments, operation of the alert mechanism to notify the user of direct user input that has been flagged as a threat comprises: triggering an alert notification on the smart card comprising an audio notification; and sending an alert notification to a user chosen secondary user device comprising a text notification.

Similarly, and as a person of skill in the art will understand, each of the features, functions, and advantages provided herein with respect to the system disclosed hereinabove may additionally be provided with respect to a computer-implemented method and computer program product. Such embodiments are provided for exemplary purposes below and are not intended to be limited.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIGS. 1A-1C illustrates technical components of an exemplary distributed computing environment for enhancing security associated with networked devices via artificial intelligence enhanced processing, in accordance with an embodiment of the disclosure;

FIG. 2 illustrates an exemplary artificial intelligence (AI) engine subsystem architecture for enhancing security associated with networked devices via artificial intelligence enhanced processing, in accordance with an embodiment of the disclosure;

FIG. 3 illustrates an exemplary Natural Language Processing (NLP) subsystem architecture for enhancing security associated with networked devices via artificial intelligence enhanced processing, in accordance with an embodiment of the disclosure;

FIG. 4 illustrates a process flow for enhancing security associated with networked devices via artificial intelligence enhanced processing, in accordance with an embodiment of the disclosure;

FIG. 5 illustrates a process flow for an orchestration engine as a step in enhancing security associated with networked devices via artificial intelligence enhanced processing, in accordance with an embodiment of the disclosure;

FIG. 6 illustrates a process flow for a cloud-based natural language application programming interface (API) for threat analytics as a step in enhancing security associated with networked devices via artificial intelligence enhanced processing, in accordance with an embodiment of the disclosure;

FIG. 7 illustrates is a process flow for a federated learning strategy for an AI or ML model as a step in enhancing security associated with networked devices via artificial intelligence enhanced processing, in accordance with an embodiment of the disclosure;

FIG. 8 illustrates a system for enhancing security associated with networked devices via artificial intelligence enhanced processing, in accordance with an embodiment of the disclosure; and

FIG. 9 illustrates a process for enhancing security associated with networked devices via artificial intelligence enhanced processing, in accordance with an embodiment of the disclosure.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of an application, or part of an application that serves as a foundation for a larger piece of software and drives the functionality of the software. In some embodiments, an engine may be self-contained, but externally-controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a “resource” may generally refer to objects, products, devices, goods, commodities, services, and the like, and/or the ability and opportunity to access and use the same. Some example implementations herein contemplate property held by a user, including property that is stored and/or maintained by a third-party entity. In some example implementations, a resource may be associated with one or more accounts or may be property that is not associated with a specific account. Examples of resources associated with accounts may be accounts that have cash or cash equivalents, commodities, and/or accounts that are funded with or contain property, such as safety deposit boxes containing jewelry, art or other valuables, a trust account that is funded with property, or the like. For purposes of this invention, a resource is typically stored in a resource repository-a storage location where one or more resources are organized, stored and retrieved electronically using a computing device.

As used herein, a “resource transfer,” “resource distribution,” or “resource allocation” may refer to any transaction, activities or communication between one or more entities, or between the user and the one or more entities. A resource transfer may refer to any distribution of resources such as, but not limited to, a payment, processing of funds, purchase of goods or services, a return of goods or services, a payment transaction, a credit transaction, or other interactions involving a user's resource or account. Unless specifically limited by the context, a “resource transfer” a “transaction”, “transaction event” or “point of transaction event” may refer to any activity between a user, a merchant, an entity, or any combination thereof. In some embodiments, a resource transfer or transaction may refer to financial transactions involving direct or indirect movement of funds through traditional paper transaction processing systems (i.e., paper check processing) or through electronic transaction processing systems. Typical financial transactions include point of sale (POS) transactions, automated teller machine (ATM) transactions, person-to-person (P2P) transfers, internet transactions, online shopping, electronic funds transfers between accounts, transactions with a financial institution teller, personal checks, conducting purchases using loyalty/rewards points etc. When discussing that resource transfers or transactions are evaluated it could mean that the transaction has already occurred, is in the process of occurring or being processed, or it has yet to be processed/posted by one or more financial institutions. In some embodiments, a resource transfer or transaction may refer to non-financial activities of the user. In this regard, the transaction may be a customer account event, such as but not limited to the customer changing a password, ordering new checks, adding new accounts, opening new accounts, adding or modifying account parameters/restrictions, modifying a payee list associated with one or more accounts, setting up automatic payments, performing/modifying authentication procedures and/or credentials, and the like.

As used herein, “payment instrument” may refer to an electronic payment vehicle, such as an electronic credit or debit card. The payment instrument may not be a “card” at all and may instead be account identifying information stored electronically in a user device, such as payment credentials or tokens/aliases associated with a digital wallet, or account identifiers stored by a mobile application.

The present disclosure provides systems, computer programs, and methods for enhancing security associated with networked devices via artificial intelligence (AI) enhanced processing. In an example embodiment, the invention discloses a data transmission device with an on-board generative AI. The data transmission devices leverage cloud-based natural language application programming interfaces (API) for threat analytics, coupled with an AI or ML model, to authenticate, in real-time, a user input into a data transmission device.

Presently, there is a demand for user devices with efficient and high-speed transmission of sensitive user data, while maintaining a high degree of security. Many instances of various unauthorized data transmissions (such as resource transmissions or resource requests for transmissions) go unnoticed by the user, with repeated cases and patterns being reported. There is scope to implement authentication security measures on user devices that proactively protect the user from unauthorized device access. The current means of authentication security for data transmissions of this nature remain limited, monolithic, and often reactive in nature. There is a need to explore authentic methods for frictionless, intelligent network data transmission systems that utilize multifactor authentication (card to person) for accurate and precise user identification. Voice-based commands to a user device need to be accurately identified and authenticated to the user of the device before initiating a data transmission. The voice-based command enabled data transmission instruction initiated between the device and a recipient of the data transmission must be mapped and executed correctly. There exist limitations when it comes to device attribute mapping with the user while initiating a data transmission which could result in unauthorized acts of data transmission, such as by a bad actor or misappropriation of a smart card and attempt to access the resources associated with the smart card.

Embodiments of the disclosure utilize a combination of AI and/or ML models to remedy the security concerns associated with voice-based data transmissions of user devices. In some embodiments of the disclosure, an on-board generative AI may be embedded on a smart card device. The on-board generative AI may analyze user voice commands and compare the current user voice command against a plurality of stored user voice commands to authenticate the user of the smart card device. Upon successful user authentication, the current user voice command, as well as data from a plurality of built-in internet of things (IoT) sensors on the smart card device, may be sent to an orchestration engine, where the orchestration engine may intake a set of user data and previous sets of stored user data. In some embodiments, the orchestration engine may curate the data and may prioritize which data elements to transfer to a cloud natural language API for threat analytics, where the cloud natural language API for threat analytics may compare the data elements from the set of user data and the previous sets of stored user data to generate a match score between like data elements.

In some embodiments, the match scores may be analyzed by an AI or ML decision maker to generate a threat score for the current voice command. Given the threat score is above a threat score threshold, the voice command may be validated, completed, and the user may be notified. Given the threat score is below the threat score threshold, the voice command may be invalidated, and the user may be notified. One of ordinary skill in the art in view of the present disclosure will recognize that smart card devices utilizing this system of multifactor authentication remedies many of the security issues faced by users of current smart card devices and other such data transmission devices.

What is more, the present invention provides a technical solution to a technical problem. As described herein, the technical problem includes authenticating a user for data transmissions. The technical solution presented herein allows for the quick and accurate identification and authentication of a user to a data transmission device before initiating a data transmission by incorporating generative AI onto the data transmission devices themselves, (i) with fewer steps to achieve the solution, thus reducing the amount of computing resources, such as processing resources, storage resources, network resources, and/or the like, that are being used (e.g., by using ML and AI techniques, the system is able to dynamically and automatically determine and authenticate a user to the data transmission device itself, without the need for additional resource use of transferring data across a network for remote authentication); (ii) providing a more accurate solution to problem, thus reducing the number of resources required to remedy any errors made due to a less accurate solution (e.g., by using ML and AI techniques (e.g., federated learning), the system may be configured to be continuously trained as new user data is generated and the system may be updated due to the training thus producing an increasingly accurate analysis of user inputs into a data transmission device); (iii) removing manual input and waste from the implementation of the solution, thus improving speed and efficiency of the process and conserving computing resources (e.g., by using generative AI, the system may be configured to proactively secure a data transmission device from unauthorized user access thus reducing user time and computational resource time spent remedying an authorized data transmission that occurred); (iv) determining an optimal amount of resources that need to be used to implement the solution, thus reducing network traffic and load on existing computing resources (e.g., by using an orchestration engine, the system may be configured to select for a precise amount of user data and prioritize specific data elements of the user data that may be required to authenticate an initiated data transmission by an AI or ML model, therefore eliminating unnecessary load on network and computing resources). Furthermore, the technical solution described herein uses a rigorous, computerized process to perform specific tasks and/or activities that were not previously performed. In specific implementations, the technical solution bypasses a series of steps previously implemented, thus further conserving computing resources.

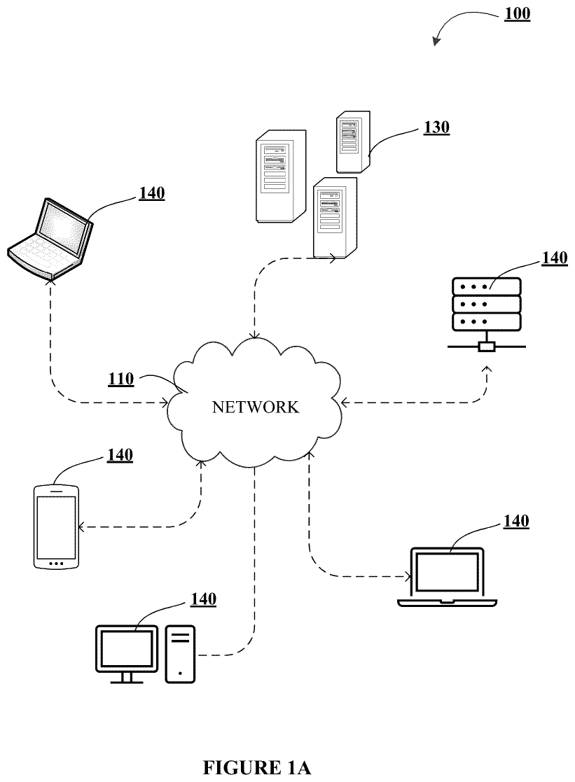

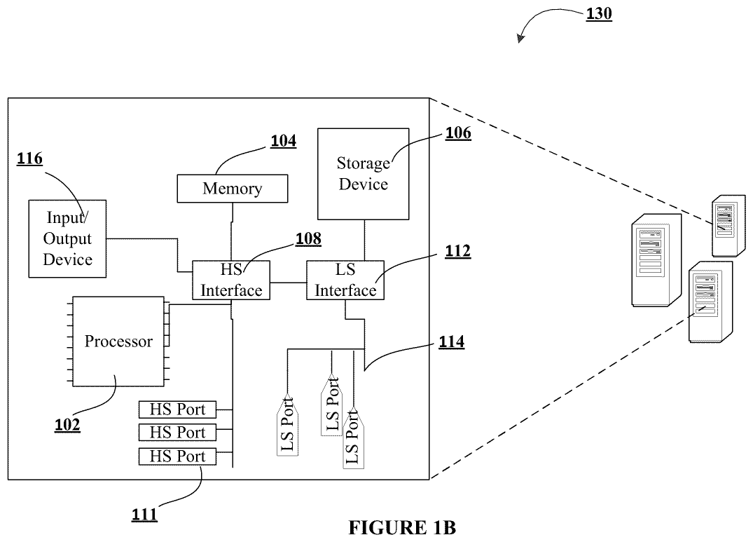

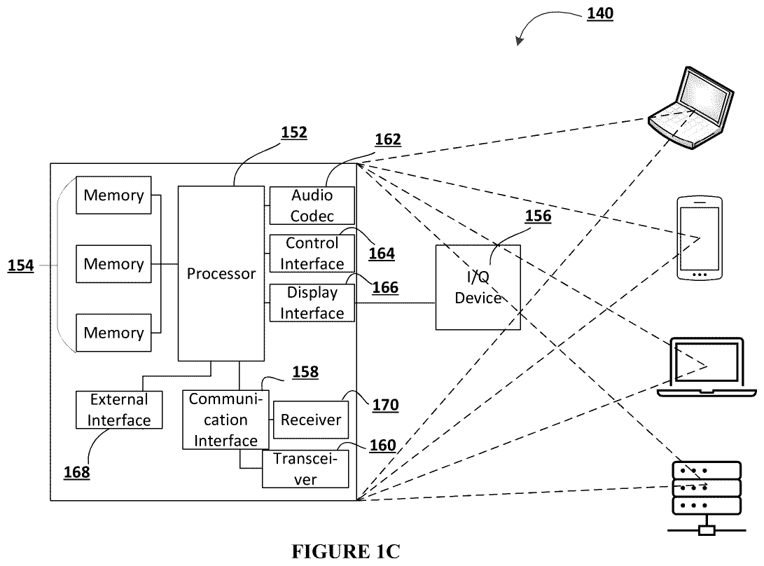

FIGS. 1A-1C illustrate technical components of an exemplary distributed computing environment for implementing AI to enhance security associated with networked devices via artificial intelligence enhanced processing, in accordance with an embodiment of the invention. As shown in FIG. 1A, the distributed computing environment 100 contemplated herein may include a system 130 (i.e., an authentication credential verification), an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the inventions described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the invention. As shown in FIG. 1B, the system 130 may include a processor 102, memory 104, input/output (I/O) device 116, and a storage device 106. The system 130 may also include a high-speed interface 108 connecting to the memory 104, and a low-speed interface 112 (shown as “LS Interface”) connecting to low speed bus 114 (shown as “LS Port”) and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 (shown as “HS Interface”) is coupled to memory 104, input/output (I/O) device 116 (e.g., through a graphics processor or accelerator), and to high-speed expansion ports 111 (shown as “HS Port”), which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, it may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the invention. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation—and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert it to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

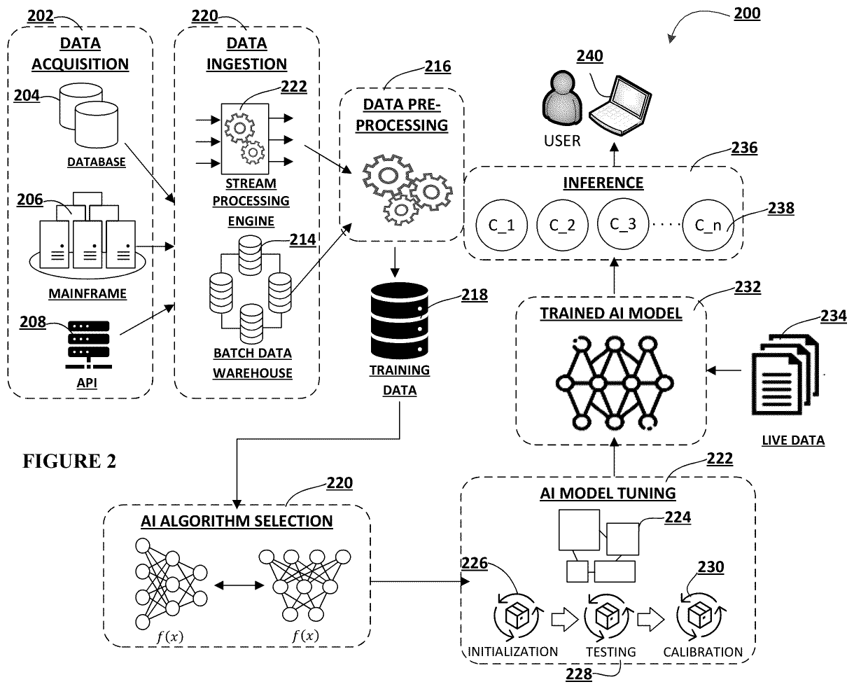

FIG. 2 illustrates an exemplary artificial intelligence (AI) engine subsystem architecture 200 for enhancing security associated with networked devices via artificial intelligence enhanced processing, in accordance with an embodiment of the disclosure. The artificial intelligence subsystem 200 may include a data acquisition engine 202, data ingestion engine 210, data pre-processing engine 216, AI engine tuning engine 222, and inference engine 236.

The data acquisition engine 202 may identify various internal and/or external data sources to generate, test, and/or integrate new features for training the artificial intelligence engine 224. These internal and/or external data sources 204, 206, and 208 may be initial locations where the data originates or where physical information is first digitized. The data acquisition engine 202 may identify the location of the data and describe connection characteristics for access and retrieval of data. In some embodiments, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources 204, 206, and 208 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 202, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In artificial intelligence, the quality of data and the useful information that can be derived therefrom directly affects the ability of the artificial intelligence engine 224 to learn. The data pre-processing engine 216 may implement advanced integration and processing steps needed to prepare the data for artificial intelligence execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and/or combine variables into features, effectively reducing the amount of data that must be processed, while still accurately and completely describing the original data set. Depending on the type of artificial intelligence algorithm being used, this training data 218 may require further enrichment. For example, in supervised learning, the training data is enriched using one or more meaningful and informative labels to provide context so a artificial intelligence engine can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The AI tuning engine 222 may be used to train an artificial intelligence engine 224 using the training data 218 to make predictions or decisions without explicitly being programmed to do so. The artificial intelligence engine 224 represents what was learned by the selected artificial intelligence algorithm 220 and represents the rules, numbers, and any other algorithm-specific data structures required for classification. Selecting the right artificial intelligence algorithm may depend on a number of different factors, such as the problem statement and the kind of output needed, type and size of the data, the available computational time, number of features and observations in the data, and/or the like. Artificial intelligence algorithms may refer to programs (math and logic) that are configured to self-adjust and perform better as they are exposed to more data. To this extent, artificial intelligence algorithms are capable of adjusting their own parameters, given feedback on previous performance in making prediction about a dataset.

The artificial intelligence algorithms contemplated, described, and/or used herein include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable artificial intelligence engine type. Each of these types of artificial intelligence algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

To tune the artificial intelligence engine, the AI tuning engine 222 may repeatedly execute cycles of experimentation 226, testing 228, and tuning 230 to optimize the performance of the artificial intelligence algorithm 220 and refine the results in preparation for deployment of those results for consumption or decision making. To this end, the AI tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the engine is the measurement used to determine which set of hyperparameters is best at identifying relationships and patterns between variables in a dataset based on the input, or training data 218. A fully trained artificial intelligence engine 232 is one whose hyperparameters are tuned and engine accuracy maximized.

The trained artificial intelligence engine 232, similar to any other software application output, can be persisted to storage, file, memory, or application, or looped back into the processing component to be reprocessed. More often, the trained artificial intelligence engine 232 is deployed into an existing production environment to make practical business decisions based on live data 234. To this end, the artificial intelligence subsystem 200 uses the inference engine 236 to make such decisions. The type of decision-making may depend upon the type of artificial intelligence algorithm used. For example, artificial intelligence engines trained using supervised learning algorithms may be used to structure computations in terms of categorized outputs (e.g., C_1, C_2 . . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, artificial intelligence engines trained using unsupervised learning algorithms may be used to group (e.g., C_1, C_2 . . . . C_n 238) live data 234 based on how similar they are to one another to solve exploratory challenges where little is known about the data, provide a description or label (e.g., C_1, C_2 . . . . C_n 238) to live data 234, such as in classification, and/or the like. These categorized outputs, groups (clusters), or labels are then presented to the user input system 130. In still other cases, artificial intelligence engines that perform regression techniques may use live data 234 to predict or forecast continuous outcomes.

It will be understood that the embodiment of the artificial intelligence subsystem 200 illustrated in FIG. 2 is exemplary and that other embodiments may vary. As another example, in some embodiments, the artificial intelligence subsystem 200 may include more, fewer, or different components.

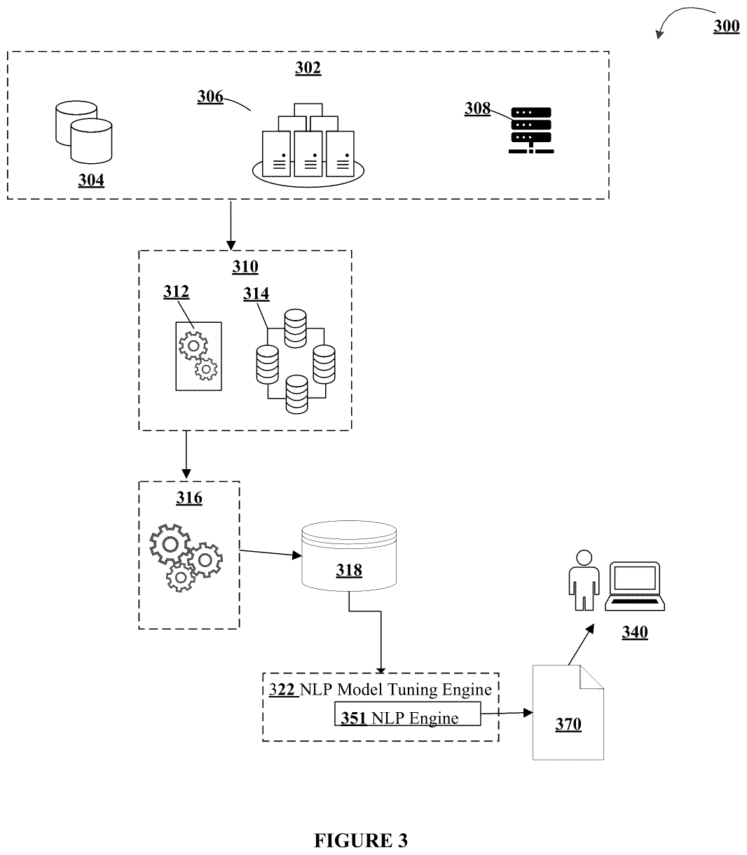

FIG. 3 illustrates an exemplary Natural Language Processing (NLP) subsystem architecture 300 for enhancing security associated with networked devices via artificial intelligence enhanced processing, in accordance with an embodiment of the disclosure. The NLP subsystem 300 may include a data acquisition engine 302, data ingestion engine 310, data pre-processing engine 316, NLP model tuning engine 322, inference engine 336, and NLP engine 351.

The data acquisition engine 302 may identify various internal and/or external data sources to generate, test, and/or integrate new features for training the NLP engine 351 (such as by gathering at least one unstructured datasets like that shown in as datasets 306). These internal and/or external data sources 304, 306, and 308 may be initial locations where the data originates or where physical information is first digitized (such as within a database, such as a database of change requests, modifications, and/or the like). The data acquisition engine 302 may identify the location of the data and describe connection characteristics for access and retrieval of data.

In some embodiments, data is transported from each data source 304, 306, or 308 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources 304, 306, and 308 may include databases associated with computer programming modifications by development teams and their associated change requests that precipitated the modifications, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 302 from these data sources 304, 306, and 308 may then be transported to the data ingestion engine 310 for further processing.

Depending on the nature of the data imported from the data acquisition engine 302, the data ingestion engine 310 may move the data to a destination for storage or further analysis. Typically, the data imported from the data acquisition engine 302 may be in varying formats as they come from different sources, including RDBMS, other types of databases, S3 buckets, CSVs, or from streams. In some embodiments, and since the data may come from different places, it may need to be cleansed and transformed so that it can be analyzed together with data from other sources, such as by cleansing the data of non-important text such as periods (“.”) and/or the like. At the data ingestion engine 302, the data may be ingested in real-time, using the stream processing engine 312, in batches using the batch data warehouse 314, or a combination of both. The stream processing engine 312 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 314 collects and transfers data in batches according to scheduled intervals, trigger events, or any other logical ordering.

In natural language processing, the quality of data and the useful information that can be derived therefrom directly affects the ability of the natural language processing engine 351. The data pre-processing engine 316 may implement advanced integration and processing steps needed to prepare the data for NLP execution. This may include modules to perform any upfront, data transformation to consolidate the data into alternate forms by changing the value, structure, or format of the data using generalization, weightage values, fuzzy the terms of the unstructured datasets, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 316 may implement feature extraction and/or selection techniques to generate training data 318. In some embodiments, the training data 318 may comprise pre-labeled modifications, natural language interpretations, and/or the like. Further, and in some embodiments, the training data 318 may be pre-labeled by users associated with the development team of the computer program(s) and/or by a user that input the change requests. Feature extraction and/or selection is a process of dimensionality reduction by which an initial set of data is reduced to more manageable groups for processing. In some embodiments, the training data 318 may require further enrichment. For example, in supervised learning, the training data is enriched using one or more meaningful and informative labels to provide context so the NLP engine 351 can learn from it. In contrast, unsupervised learning uses unlabeled data to find patterns in the data, such as inferences or clustering of data points, such as by being trained on non-labeled change requests and associated modifications.

An NLP engine tuning engine 322 may be used to train the NLP engine 351 using the training data 318 to make predictions or decisions without explicitly being programmed to do so. The NLP engine 351 represents what was learned by a selected machine learning algorithm 320 and represents the rules, numbers, and any other algorithm-specific data structures required for classification.

In some embodiments, the NLP engine 351 may include machine learning supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

To tune the NLP engine 351, the NLP tuning engine 322 may repeatedly execute cycles of experimentation, testing, and tuning to optimize the performance of the NLP engine 351 and refine the results in preparation for deployment of those results for consumption or decision making. To this end, the NLP tuning engine 322 may vary hyperparameters each iteration, run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 318. A fully trained NLP engine 351 is one whose hyperparameters are tuned and accuracy maximized.

The trained NLP engine 351, similar to any other software application output, can be persisted to storage, file, memory, or application, or looped back into the processing component to be reprocessed. More often, the trained NLP engine 351 is deployed into an existing production environment to make accurate decisions on unstructured data based on live data (e.g., unstructured datasets and input data). For instance, such an unstructured dataset/a plurality of future unstructured datasets may be input to the training NLP engine 351 (which includes parsing the terms of the unstructured dataset(s), determining the meaning of each of the modifications and their purposes within the computer program, the meaning of the change requests, and/or the like. Further, and based on the structured dataset generated by the trained NLP engine 351, the computer language interpretation system may generate an interface component (e.g., a modification interpretation database, and/or the like).

It will be understood that the embodiment of the NLP subsystem 300 illustrated in FIG. 3 is exemplary and that other embodiments may vary. As another example, in some embodiments, the NLP subsystem 300 may include more, fewer, or different components.

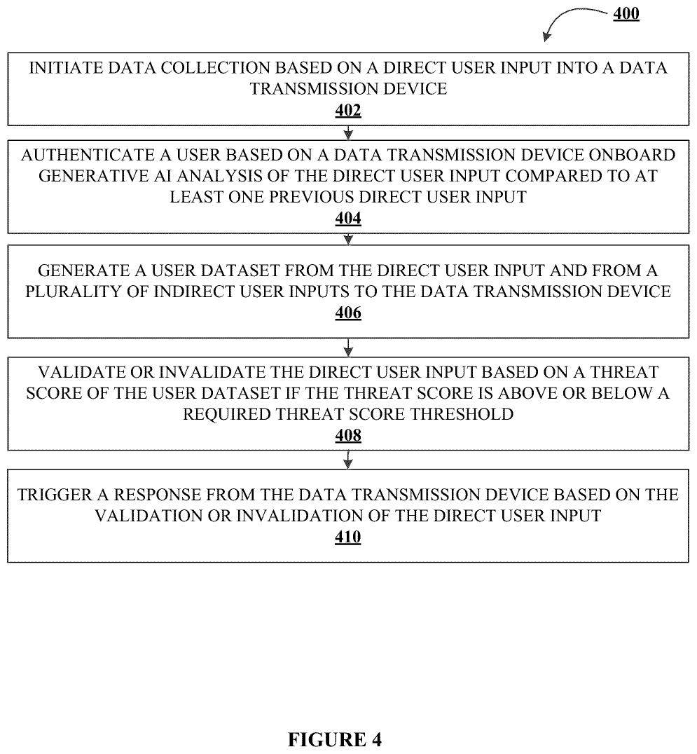

FIG. 4 illustrates a process flow 400 for enhancing security associated with networked devices via artificial intelligence enhanced processing, in accordance with an embodiment of the disclosure. In some embodiments, a system (e.g., similar to one or more of the systems described herein with respect to FIGS. 1A-1C) may perform one or more of the steps of process flow 400. For example, an authentication credential verification system (e.g., the system 130 described herein with respect to FIG. 1A-1C) may perform the steps of process 400. In some embodiments, an artificial intelligence engine (e.g., such as the AI engine shown in FIG. 2) may perform some or all of the steps described in process flow 400. In some embodiments, an NLP engine (e.g., such as the NLP engine shown in FIG. 3) may perform some or all of the steps described in process flow 400.

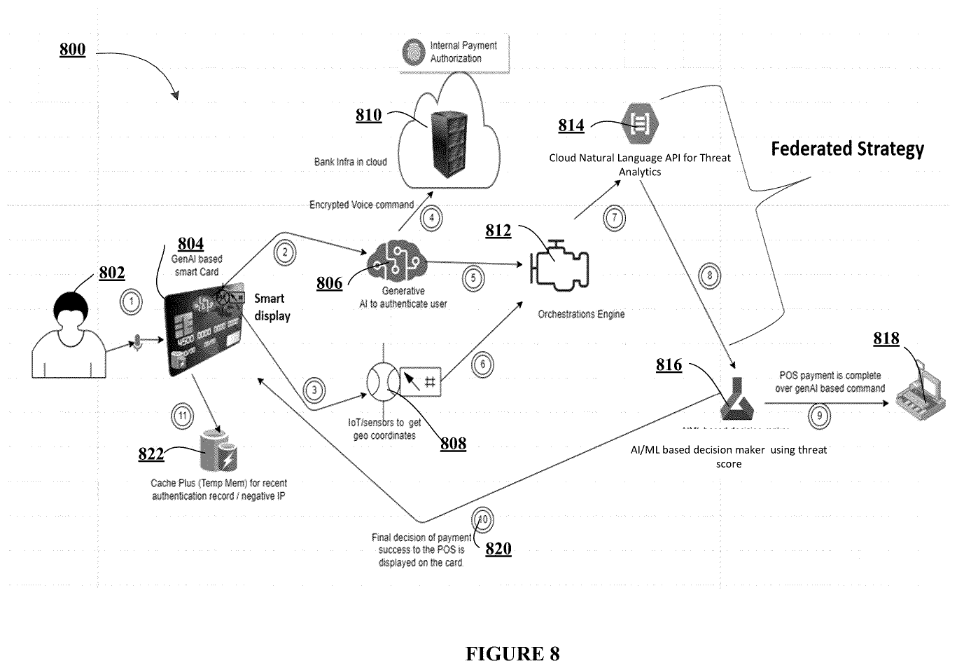

As shown in block 402, the process flow 400 may include the step of initiating data collection based on direct user input into a data transmission device. In some embodiments, initiation of the process flow 400 may be accomplished via a user of the data transmission device inputting a command to the data transmission device. For example, the user may input a voice command to the data transmission device (e.g., a user may input or generate a statement of a task to a smart card device and such an example is shown and described in more detail below with respect to FIG. 8) which upon transmission of the user voice command to the data transmission device, the data transmission device may begin data collection in accordance with an embodiment of the present disclosure. In some embodiments, data collection performed by the data transmission device may comprise storing of the direct user input (e.g., the user voice command). Additionally, and/or alternatively, data collection may comprise storing of a plurality of indirect user inputs (e.g., a geocoordinate, an internet protocol (IP) address, a device identifier (ID), and/or the like) via elements of the data transmission device (e.g., via one or more sensors, one or more geo coordinate components or devices, one or more network towers, internet protocol command tools, and/or the like). In some embodiments, a data transmission device may comprise any networked devices authenticated to a user (e.g., a smart card device).

As shown in block 404, the process flow 400 may include the step of authenticating a user based on a data transmission device onboard generative AI analysis of the direct user input compared to at least one previous direct user input. In some embodiments, authentication of the user in the process flow 400 may be accomplished via a comparison of a current user voice command to the data transmission device and one or more previous user voice commands stored in a cloud-based infrastructure (e.g., a cloud-based bank infrastructure and such an example is shown and described in more detail below with respect to FIG. 8). For example, the onboard generative AI (e.g., an onboard generative AI and such an example is shown and described in more detail below with respect to FIG. 8) will analyze aspects of the voice command input (e.g., cadence, tone, and/or other voice characteristics) and compare the analyzed voice command input against previous analyses of authenticated user voice commands. The generative AI may conclude the match between the voice command input and previous voice command inputs is above a required value (e.g., an AI generates a visual representation of one or more audio features of a voice command input and the AI uses image recognition techniques to associate values to the visual representation of the one or more audio features coupled with values of past user voice command audio features to calculate a probability of user authenticity), allowing the process of data transmission to continue, in accordance with an embodiment of the present disclosure.

As shown in block 406, the process flow 400 may include the step of generating a user dataset from the direct user input and from a plurality of indirect user inputs to the data transmission device. In some embodiments, generating a user dataset in the process flow 400 may include aggregating a plurality of data elements (e.g., a user voice command, a geocoordinate, an internet protocol (IP) address, a device identifier (ID), and/or the like) collected by elements of the data transmission device into a data structure (e.g., an array, stack, table, dataset, and/or the like) for transfer for data curation (e.g., transfer to an orchestration engine and such an example is shown and described in more detail below with respect to FIG. 8). In some embodiments, in an event of a disruption of a data transmission process (e.g., the user dataset is not transferred to a data orchestration engine) the data transmission may be terminated, and recent user authentication records may be temporarily stored in memory on the data transmission device for reuse in future data transmissions within a threshold time.

As shown in block 408, the process flow 400 may include the step of validating or invalidating the direct user input based on a threat score of the user dataset if the threat score is above or below a required threat score threshold. In some embodiments, validating or invalidating the direct user input in the process flow 400 may include an analysis of user data (e.g., the user dataset as described herein and as shown in block 406) by an NLP model (e.g., a cloud-based natural language API and such an example is shown and described in more detail below with respect to FIG. 8) and an AI or ML based decision of the analyzed user dataset (e.g., an AI or ML based decision maker and such an example is shown and described in more detail below with respect to FIG. 8).

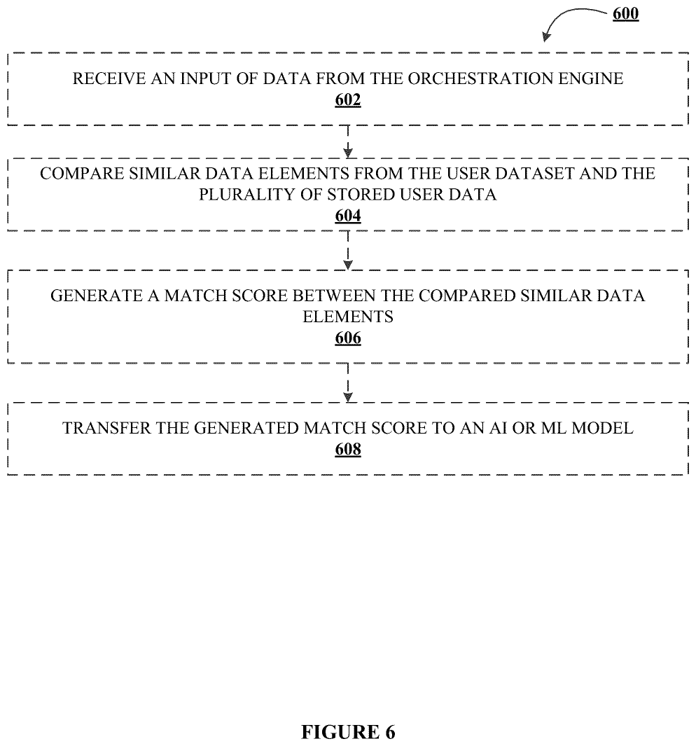

For example, in some embodiments, data elements (e.g., a user voice command, a geocoordinate, an internet protocol (IP) address, or a device identifier (ID)) of the user dataset will be transferred to a cloud-based natural language API for threat analytics that may be configured to compare the data elements against similar stored data elements of the user (e.g., is the present user geocoordinate consistent with past user geocoordinates) in order to generate a match score for each data element. Additionally, and/or alternatively, the generated match scores are transferred to an AI or ML based decision maker that may be configured to generate, using the generated match scores, a threat score of the direct user input, where the direct user input may be validated or invalidated if the threat score is above or below a required threat score threshold (e.g., a threat score value may be calculated by an AI or ML decision maker using the match scores of like data elements from an NLP as inputs (e.g., a dot product of a weight vector of a trained AI or ML decision maker and a match score vector divided by the sum of the weight vector), the AI or ML decision maker may require a threat score of 90 or greater for the direct user input to be validated, and the AI or ML decision maker may send an instruction to a data transmission device to terminate a data transmission in the event the threat score value is below 90). Such match scores are described in further detail herein with respect to FIG. 6.

As shown in block 410, the process flow 400 may include the step of triggering a response from the data transmission device based on the validation or invalidation of the direct user input. In some embodiments, triggering a response from the data transmission device in the process flow 400 may include an alert mechanism configured to trigger an alert notification (e.g., an audio alarm, a visual on a digital display, and/or the like) based on an invalidation of the direct user input. Further, operation of the alert mechanism to notify the user of direct user input that has been flagged as a threat includes triggering an alert notification on the data transmission device comprising an audio notification and sending an alert notification to a user chosen secondary user device. Additionally, and/or alternatively, operation of the alert mechanism to notify the user of direct user input that has been authenticated may include triggering an alert notification on the data transmission device comprising a visual message on a digital display on the data transmission device.

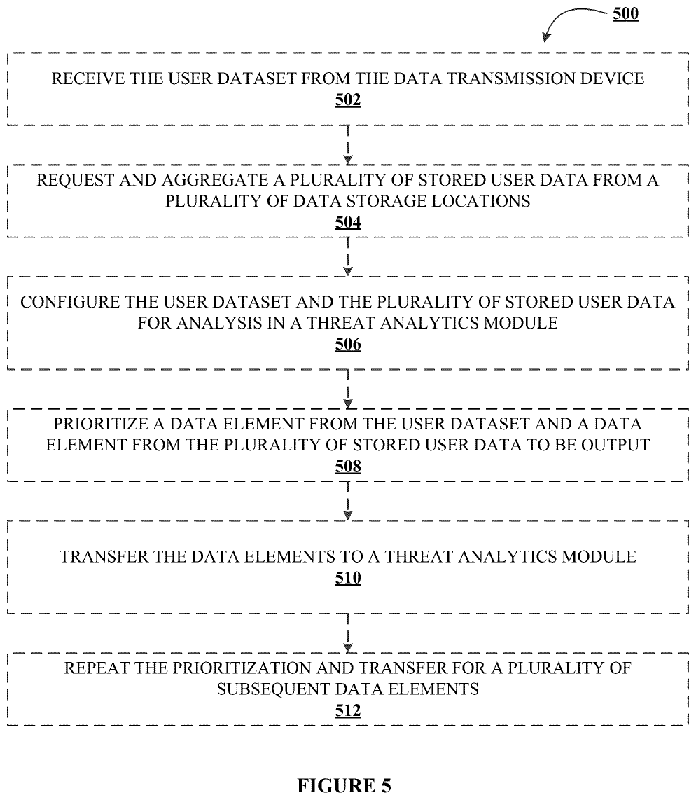

FIG. 5 illustrates a process flow 500 for an orchestration engine as a step in enhancing security associated with networked devices via artificial intelligence enhanced processing, in accordance with an embodiment of the disclosure. In some embodiments, a system (e.g., similar to one or more of the systems described herein with respect to FIGS. 1A-1C) may perform one or more of the steps of process flow 400. For example, an authentication credential verification system (e.g., the system 130 described herein with respect to FIG. 1A-1C) may perform the steps of process 500. In some embodiments, an artificial intelligence engine (e.g., such as the AI engine shown in FIG. 2) may perform some or all of the steps described in process flow 500. In some embodiments, an NLP engine (e.g., such as the NLP engine shown in FIG. 3) may perform some or all of the steps described in process flow 500.

In some embodiments, and as shown in block 502, the process flow 500 may include the step of receiving the user dataset from the data transmission device. In some embodiments, the user dataset may be received from the data transmission device via a cloud-based data exchange for further data curation for use in AI or ML models. Further, the user data may be received from the data transmission device by an engine designed to curate or refine the user dataset for further use (e.g., an orchestration engine and such an example is shown and described in more detail below with respect to FIG. 8). In some embodiments, the process described with respect to block 502 may follow the process described with respect to block 406 of FIG. 4.

In some embodiments, and as shown in block 504, the process flow 500 may include the step of requesting and aggregating a plurality of stored user data from a plurality of data storage locations. In some embodiments, the requesting of the plurality of stored user data may be performed by an engine for curating data (e.g., an orchestration engine and such an example is shown and described in more detail below with respect to FIG. 8). Additionally, and/or alternatively, the requested plurality of stored user data may be aggregated in a single, temporary data location (e.g., an orchestration engine and such an example is shown and described in more detail below with respect to FIG. 8) and the requested plurality of stored user data may be further curated for transfer for further analysis by other data processing modules (e.g., an AI or ML model).

In some embodiments, and as shown in block 506, the process flow 500 may include the step of configuring the user dataset and the plurality of stored user data for analysis in a threat analytics module. In some embodiments, the configuring of the user dataset and the plurality of stored user data may include matching like data elements from the user dataset and the plurality of stored user data (e.g., a geocoordinate is extracted from the user dataset and paired with a plurality of geocoordinates extracted from the plurality of stored user data), assigning a priority metric based on the needs of an AI or ML model (e.g., the AI or ML model may prioritize paired audio feature data elements first for analysis), reconfiguring the data into an alternate data form based on the needs of the AI or ML model (e.g., the AI or ML model may be configured to require one or more data structure types as input), and/or the like. Additionally, and/or alternatively, the configuration may be performed by an orchestration engine and such an example is shown and described in more detail below with respect to FIG. 8. In some embodiments, the threat analytics module may be a natural language processing (NLP) model (e.g., a cloud-based natural language API and such an example is shown and described in more detail below with respect to FIG. 8).

In some embodiments, and as shown in block 508, the process flow 500 may include the step of prioritizing a data element from the user dataset and a data element from the plurality of stored user data to be output. In some embodiments, the prioritization of the data element may be performed by a data engine (e.g., an orchestration engine and such an example is shown and described in more detail below with respect to FIG. 8) and the prioritization may be based on the priority metrics of an NLP model (e.g., a cloud-based natural language API and such an example is shown and described in more detail below with respect to FIG. 8). Further, the prioritization may be performed due to a specific data element being required next for analysis based on the priority metrics of the NLP model.

For example, the NLP model may prioritize a data element based on an average time of analysis for data elements of that type, a metric of influence (e.g., a higher weight coefficient) data elements of that type have in calculations, an amount of computing resources required to analyze data elements of that type, and/or the like (e.g., the NLP model may be configured to prioritize the data element types such that a wait time and/or an amount of computing resources is minimized on average). Further, in the event the NLP model has an equivalent priority metric for two data elements, the data engine may be configured to select one of the two data element options to transfer first.

In some embodiments, and as shown in block 510, the process flow 500 may include the step of transferring the prioritized data elements to a threat analytics module. In some embodiments, the prioritized data elements may be used in evaluating a user data transmission such as in an analysis of the prioritized data elements by a threat analytics module (e.g., a cloud-based natural language API and such an example is shown and described in more detail below with respect to FIG. 8). Further, the data engine (e.g., an orchestration engine and such an example is shown and described in more detail below with respect to FIG. 8) transferring the prioritized data elements may be configured to transfer the prioritized data elements via a cloud-based data transmission to the threat analytics module for analysis of the prioritized data elements.

In some embodiments, and as shown in block 512, the process flow 500 may include the step of repeating the prioritization and transfer for a plurality of subsequent data elements. For example, in some embodiments, the threat analytics module (e.g., a cloud-based natural language API and such an example is shown and described in more detail below with respect to FIG. 8) may be configured to use a plurality of different data elements in a set order (i.e., based on the order of prioritization from block 508). Such a plurality of data elements may be analyzed by the threat analytics module sequentially and as a step-by-step process, such that a data engine (e.g., an orchestration engine and such an example is shown and described in more detail below with respect to FIG. 8) repeats the prioritization, as shown in block 508, and transfer, as shown in block 510, process until each necessary data element is analyzed.

FIG. 6 illustrates a process flow 600 for a cloud-based natural language application programming interface (API) as a step in enhancing security associated with networked devices via artificial intelligence enhanced processing, in accordance with an embodiment of the disclosure. In some embodiments, a system (e.g., similar to one or more of the systems described herein with respect to FIGS. 1A-1C) may perform one or more of the steps of process flow 600. For example, an authentication credential verification system (e.g., the system 130 described herein with respect to FIG. 1A-1C) may perform the steps of process 600. In some embodiments, an artificial intelligence engine (e.g., such as the AI engine shown in FIG. 2) may perform some or all of the steps described in process flow 600. In some embodiments, an NLP engine (e.g., such as the NLP engine shown in FIG. 3) may perform some or all of the steps described in process flow 600.

In some embodiments, and as shown in block 602, the process flow 600 may include the step of receiving an input of data (e.g., the prioritized data elements described herein with respect to FIG. 5) from the orchestration engine. In some embodiments, the input of data may be received by an AI or ML model from the orchestration engine via a cloud-based data exchange for use in the AI or ML model. Further, the input of data may be received from the orchestration engine by an NLP model (e.g., a cloud-based natural language API and such an example is shown and described in more detail below with respect to FIG. 8). In some embodiments, the process described with respect to block 602 may proceed from the process described with respect to block 510 of FIG. 5.

In some embodiments, and as shown in block 604, the process flow 600 may include the step of comparing similar data elements from the user dataset and the plurality of stored user data. For example, a user dataset may contain a plurality of different data elements from a direct or indirect user input (e.g., a user voice command, a geocoordinate, an internet protocol (IP) address, a device identifier (ID), and/or the like) and the plurality of stored user data may contain a plurality of different data elements from past direct or indirect user inputs. In some embodiments, the data elements of the user dataset may have at least one data element match in the data elements (e.g., a device ID of the indirect user input at a current time and the device ID of stored user data) of the plurality of stored user data, where the matched data elements are compared (e.g., checked for similarity in value, geocoordinate, identifier, and/or the like). For example, the user dataset and the plurality of stored user data may contain a user geocoordinate data element that are checked against one another for consistency. Additionally, and/or alternatively, other like data elements (i.e., of the same type) of the user dataset and plurality of stored user data may be compared.

In some embodiments, and as shown in block 606, the process flow 600 may include the step of generating a match score between the compared similar data elements. In some embodiments, the match score may be a measure of how similar or dissimilar compared data elements are (e.g., a numeric value associated with a scale). Further, the match score is generated via this comparison of similarity between the compared similar data elements. For example, the compared similar data elements may include user geocoordinates, where geocoordinates that vary significantly in value (e.g., a data transmission in one continent versus a data transmission in another continent) may result in a low match score or geocoordinates that have little to no variance in value (e.g., data transmissions in the same zip code) may result in a high match score. Additionally, and/or alternatively, other compared similar data elements may have a match score generated.

In some embodiments, and as shown in block 608, the process flow 600 may include the step of transferring the generated match score to an AI or ML model. In some embodiments, the generated match scores may be used in evaluating a user data transmission such as in an analysis of the generated match scores by an AI or ML model. Further, the NLP model generating the match scores may be configured to transfer the generated match scores via a cloud-based data transmission to the AI or ML model for analysis of the generated match scores (e.g., calculating a threat score from generated match scores as shown and described herein with respect to block 408 of the process flow 400).

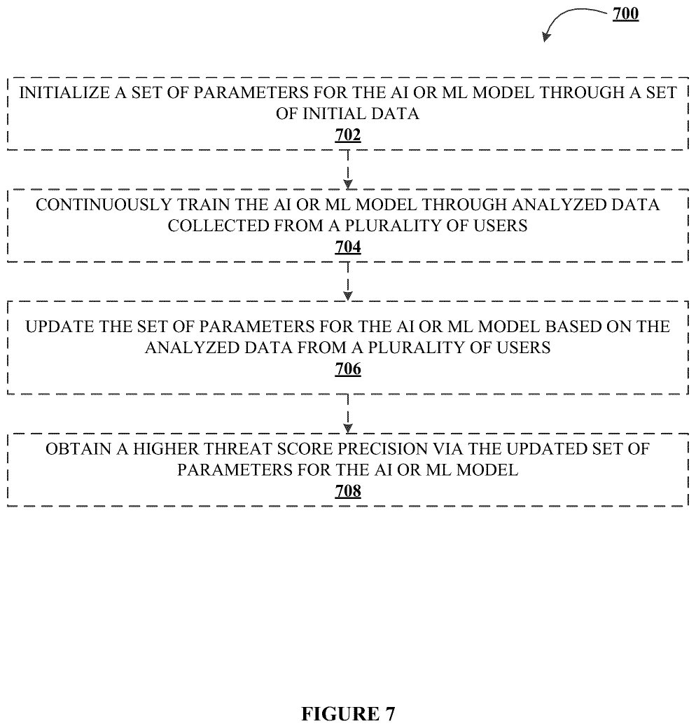

FIG. 7 illustrates a process flow 700 for a federated learning strategy for an AI or ML model as a step in enhancing security associated with networked devices via artificial intelligence enhanced processing, in accordance with an embodiment of the disclosure. In some embodiments, a system (e.g., similar to one or more of the systems described herein with respect to FIGS. 1A-1C) may perform one or more of the steps of process flow 700. For example, an authentication credential verification system (e.g., the system 130 described herein with respect to FIG. 1A-1C) may perform the steps of process 700. In some embodiments, an artificial intelligence engine (e.g., such as the AI engine shown in FIG. 2) may perform some or all of the steps described in process flow 700. In some embodiments, an NLP engine (e.g., such as the NLP engine shown in FIG. 3) may perform some or all of the steps described in process flow 700.

In some embodiments, and as shown in block 702, the process flow 700 may include the step of initializing a set of parameters for the AI or ML model through a set of initial data. In some embodiments, the AI or ML model (e.g., an AI or ML based decision maker) may have a set of parameters (e.g., variables, weights, biases, scaling factors, and/or the like), for analysis of a dataset, that may each be set to an initial value determined by AI or ML parameter initialization techniques (e.g., random initialization, uniform initialization, constant initialization, etc.). Further, the set of parameters may be updated to produce more accurate results of the AI or ML model as results and outputs are generated by the AI or ML model and feedback is received from each result/output. As will be appreciated by one of ordinary skill in the art in view of the present disclosure, new AI or ML models may be first trained on a set of initial data (e.g., training data) to generate improved initial values for the set of parameters of the AI or ML model prior to use or further updating of the set of parameters.

In some embodiments, and as shown in block 704, the process flow 700 may include the step of continuously training the AI or ML model through analyzed data collected from a plurality of users. In some embodiments, continuously training the AI or ML model may include automatically and constantly updating the values of the model parameters due to the incorporation on new analyzed data from a plurality of users. Further, continuously training an AI or ML model may increase the reliability and the accuracy of the outputs of the AI or ML model. For example, an AI or ML model may note one model parameter (e.g., a bias, a weight, etc.) is deficient in response to a new set of analyzed data from a plurality of users and shift the value of the one model parameter to adjust the output of the AI or ML model. In some embodiments, the process described with respect to block 704 may proceed from the process described with respect to block 608 of FIG. 6.

In some embodiments, and as shown in block 706, the process flow 700 may include the step of updating the set of parameters for the AI or ML model based on the analyzed data from a plurality of users. In some embodiments, incorporation of new analyzed data from a plurality of users into an AI or ML model can improve accuracy of the output of the AI or ML model via changing the values of the set of parameters based on the results of model training on the new analyzed data from a plurality of users (e.g., fine-tuning). In some embodiments, the values of the set of parameters may be adjusted due to the results of model training on the analyzed data from a plurality of users (e.g., fine-tuning). Further, the updated set of parameters may improve the accuracy of the output of the AI or ML model on new data from a plurality of users. Additionally, and/or alternatively, updating the set of parameters of the AI or ML model based on new analyzed data from a plurality of users may maintain the effectiveness of the AI or ML model in the area of use of the AI or ML model.

In some embodiments, and as shown in block 708, the process flow 700 may include the step of obtaining a higher threat score precision via the updated set of parameters for the AI or ML model. In some embodiments, the threat score precision of the AI or ML model may determine how accurate an output (e.g., if a data transmission is valid or invalid) of the AI or ML model may be. Further, the higher threat score precision may result in a higher rate of occurrence of correct outputs and a lower rate of occurrence of incorrect outputs of the AI or ML model. Additionally, and/or alternatively, the threat score precision may be influenced by a choice in values for the set of parameters for the AI or ML model, and continuously updating the parameters based on newly analyzed data may result in a higher threat score precision.

FIG. 8 illustrates a system 800 for enhancing security associated with networked devices via artificial intelligence enhanced processing, in accordance with an embodiment of the disclosure. In some embodiments, a system (e.g., similar to one or more of the systems described herein with respect to FIGS. 1A-1C) may perform one or more of the steps described in system 800. For example, an authentication credential verification system (e.g., the system 130 described herein with respect to FIG. 1A-1C) may perform the steps described in system 800. In some embodiments, an artificial intelligence engine (e.g., such as the AI engine shown in FIG. 2) may perform some or all of the steps described in system 800. In some embodiments, an NLP engine (e.g., such as the NLP engine shown in FIG. 3) may perform some or all of the steps described in system 800.

In some embodiments, the system 800 may include a user 802 which generates a user input received by a smart card device (i.e., a data transmission device) 804, authenticated to the user 802. A user 802 may input a voice command (e.g., a user input) to the smart card device 804. The system 800 may further include a generative AI 806 onboard the smart card device 804 configured to receive the voice command input from the user 802. The generative AI 806 may analyze the voice command input and compare the voice command input against a plurality of previous user voice commands stored in the cloud-based bank infrastructure 810.

In some embodiments, as the generative AI 806 is authenticating the user voice command, at least one internet of things (IoT) sensor(s) 808 embedded on the smart card device 804 may be configured to collect a plurality of indirect user inputs including a geocoordinate, an internet protocol (IP) address, a device identifier (ID), a user voice sample, and/or the like. Upon successful user authentication, the voice command input and the plurality of indirect user inputs may be transferred to an orchestration engine 812, where the orchestration engine 812 may be configured to aggregate the voice command input, the plurality of indirect user inputs, and datasets of previous user data from a plurality of storage locations.

In some embodiments, the orchestration engine 812 prioritizes a first data element from the user inputs and previous user inputs to transfer to a cloud-based natural language API for threat analytics 814, where the cloud-based natural language API for threat analytics 814 may be configured to generate a match score between the like data elements and transfer the match scores to an AI or ML based decision maker 816. The AI or ML based decision maker 816 may be configured to generate, using the match scores, a threat score and validate or invalidate the voice command input if the threat score is above or below a threat score threshold. In some embodiments, the decision 820 of the AI or ML based decision maker 816 and the result of the voice command input may be displayed on the built-in digital display on the smart card device 804.

In some embodiments, a smart card device 804 may further comprise at least one non-transitory memory, where the at least one non-transitory memory device may be a cache temporary memory device 822 that may be configured to temporarily store a plurality of user authentication data for reuse in an instance of a disruption of a user requested task to enable high-speed user authentication and seamless smart card device operation flow.

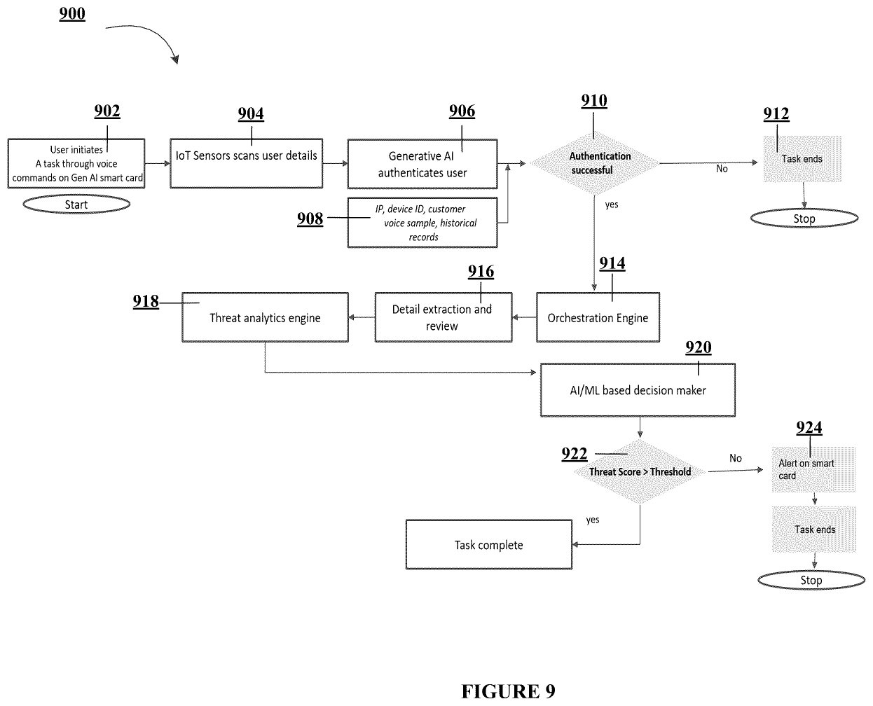

FIG. 9 illustrates a process 900 taken to enhance security associated with networked devices via artificial intelligence enhanced processing, in accordance with an embodiment of the disclosure. In some embodiments, a system (e.g., similar to one or more of the systems described herein with respect to FIGS. 1A-1C) may perform one or more of the steps of process 900. For example, an authentication credential verification system (e.g., the system 130 described herein with respect to FIG. 1A-1C) may perform the steps of process 900. In some embodiments, an artificial intelligence engine (e.g., such as the AI engine shown in FIG. 2) may perform some or all of the steps described in process 900. In some embodiments, an NLP engine (e.g., such as the NLP engine shown in FIG. 3) may perform some or all of the steps described in process 900.

In some embodiments, the process 900 for enhancing security associated with networked devices via artificial intelligence enhanced processing may begin with step 902, where a user initiates a data transmission via a voice command input to a smart card device with onboard generative AI.

In some embodiments, the process 900 may include a step 904 following step 902, where the smart card device has a plurality of IoT sensors that may be configured to collect a plurality of indirect user inputs including a geocoordinate, an internet protocol (IP) address, a device identifier (ID), or a user voice sample.

In some embodiments, the process 900 may include a step 906 following step 904, where the onboard generative AI authenticates the user by analyzing the voice command input against a plurality of previous voice command inputs of the user.

In some embodiments, the process 900 may include a step 908 simultaneous to step 906, where a plurality of previous user data including a device ID, IP address, user voice sample, or historical records are aggregated for use upon successful user authentication.

In some embodiments, the process 900 may include a step 910 following step 906 and 908, where a decision regarding the authenticity of the user voice command input is made by the onboard generative AI.

In some embodiments, the process 900 may include a step 912 following step 910, where, upon non-successful user authentication, the initiated data transmission (e.g., a resource transaction request) is terminated and fails to complete.

In some embodiments, the process 900 may include a step 914 following step 910, where, upon successful user authentication, an orchestration engine aggregates a plurality of user data from a plurality of data storage locations. In some embodiments, the data that is aggregated by the orchestration engine may be the data collected from steps 902, 904, or 908.

In some embodiments, the process 900 may include a step 916 following step 914, where the orchestration engine prioritizes a data element from the aggregated user data to first transfer for further analysis.

In some embodiments, the process 900 may include a step 918 following step 916, where the data elements prioritized by the orchestration engine may be transferred to a cloud-based natural language API for threat analytics, and where like data elements are compared to generate a match score for that data element. In some embodiments, the data elements include user voice commands, a device ID, IP address, user voice sample, or historical records.

In some embodiments, the process 900 may include a step 920 following step 918, where the generated match scores may be passed to an AI or ML based decision maker that generates a threat score based on the generated match scores of the user data.

One of ordinary skill in the art in view of the present disclosure will appreciate that this method of updating and using global cloud-based models on a plurality of local user data may be a federated learning strategy.

In some embodiments, the process 900 may include a step 922 following step 920, where the generated threat score of the user data may be compared against a threat score threshold to check for the validity of the user-initiated task. Upon successful validation of the user-initiated data transmission, the user-initiated data transmission (e.g., the resource transaction request) may be performed and completed by the smart card device with onboard generative AI. In some embodiments, a built-in digital display on the smart card device shows a result of the completed data transmission.

In some embodiments, the process 900 may include a step 924 following step 922, where the user-initiated data transmission fails to be validated (e.g., the threat score was below a set threat score threshold) and the user-initiated data transmission terminates and fails to complete. In some embodiments, the termination of a user-initiated data transmission may be accompanied by an alert on the smart card device (e.g., an audio notification).

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F #.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These computer-executable program code portions execute via the processor of the computer and/or other programmable data processing apparatus and create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for enhancing security associated with networked devices via artificial intelligence (AI) enhanced processing, the system comprising:
a memory device with computer-readable program code stored thereon;
at least one processing device operatively coupled to the at least one memory device and the at least one communication device, wherein executing the computer-readable code is configured to cause the at least one processing device to:
initiate data collection based on a direct user input into a data transmission device;
authenticate a user based on a data transmission device onboard generative artificial intelligence (AI) analysis of the direct user input compared to at least one previous direct user input;
generate, in response to the authentication, a user dataset from the direct user input and from a plurality of indirect user inputs to the data transmission device;
validate the direct user input based on a threat score of the user dataset if the threat score of the user dataset is above a required threat score threshold or invalidate the direct user input if the threat score of the user dataset is below the required threat score threshold; and
trigger a response from the data transmission device based on the validation or the invalidation of the direct user input.

2. The system of claim 1, wherein the authentication of the user is based on the direct user input, and the direct user input comprises a user voice command that is encrypted and compared with a plurality of stored user voice commands.

3. The system of claim 1, wherein the user dataset is transferred to an orchestration engine configured to:
receive the user dataset from the data transmission device;
request and aggregate a plurality of stored user data from a plurality of data storage locations, wherein the plurality of stored user data comprises previous direct user inputs and indirect user inputs;
configure the user dataset and the plurality of stored user data for analysis in a threat analytics module;
prioritize a data element from the user dataset and a data element from the plurality of stored user data to be output;
transfer the data elements to a threat analytics module; and
repeat the prioritization and transfer for a plurality of subsequent data elements.

4. The system of claim 3, wherein the threat analytics module is a cloud-based natural language application programming interface (API) for threat analytics configured to:
receive an input of data from the orchestration engine;
compare similar data elements from the user dataset and the plurality of stored user data;
generate a match score between the compared similar data elements; and
transfer the generated match scores to an AI or machine learning (ML) model.

5. The system of claim 4, wherein the AI or ML model is continuously trained through a federated learning strategy comprising:
initializing a set of parameters for the AI or ML model through a set of initial data;
continuously training the AI or ML model through analyzed data collected from a plurality of users;
updating the set of parameters for the AI or ML model based on the analyzed data from a plurality of users; and
obtaining a higher threat score precision via the updated set of parameters for the AI or ML model,
wherein the trained AI or ML model is configured to intake the generated match scores and generate the threat score based on an assessment of the generated match scores.

6. The system of claim 1, wherein the data transmission device is a smart card device further comprising:
the on-board generative AI;
at least one built in internet of things (IoT) sensor associated with collecting user data comprising a geocoordinate, an internet protocol (IP) address, a device identifier (ID), or a user voice sample;
a digital display which is configured to display a set of relevant data based on a user requested task;
an alert mechanism configured to trigger an audio notification based on an invalidation of the direct user input; and
at least one non-transitory memory device that stores temporary data.

7. The system of claim 6, wherein the at least one non-transitory memory device is a cache temporary memory device that is configured to temporarily store a plurality of user authentication data for reuse in an instance of a disruption of a user requested task.

8. The system of claim 6, wherein operation of the alert mechanism to notify the user of direct user input that has been flagged as a threat comprises:
triggering an alert notification on the smart card comprising an audio notification; and
sending an alert notification to a user chosen secondary user device comprising a text notification.

9. A computer program for enhancing security associated with networked devices via AI enhanced processing, the computer program product comprising a non-transitory computer-readable medium comprising code causing an apparatus to:
initiate data collection based on a direct user input into a data transmission device;
authenticate a user based on a data transmission device onboard generative AI analysis of the direct user input compared to at least one previous direct user input;
generate, in response to the authentication, a user dataset from the direct user input and from a plurality of indirect user inputs to the data transmission device;
validate the direct user input based on a threat score of the user dataset if the threat score of the user dataset is above a required threat score threshold or invalidate the direct user input if the threat score of the user dataset is below the required threat score threshold; and
trigger a response from the data transmission device based on the validation or the invalidation of the direct user input.

10. The computer program of claim 9, wherein the user dataset is transferred to an orchestration engine configured to:
receive the user dataset from the data transmission device;
request and aggregate a plurality of stored user data from a plurality of data storage locations, wherein the plurality of stored user data comprises previous direct user inputs and indirect user inputs;
configure the user dataset and the plurality of stored user data for analysis in a threat analytics module;
prioritize a data element from the user dataset and a data element from the plurality of stored user data to be output;
transfer the data elements to a threat analytics module; and
repeat the prioritization and transfer for a plurality of subsequent data elements.

11. The computer program of claim 10, wherein the threat analytics module is a cloud-based natural language application programming interface (API) for threat analytics configured to:
receive an input of data from the orchestration engine;
compare similar data elements from the user dataset and the plurality of stored user data;
generate a match score between the compared similar data elements; and
transfer the generated match scores to an AI or ML model.

12. The computer program of claim 11, wherein the AI or ML model is continuously trained through a federated learning strategy comprising:
initializing a set of parameters for the AI or ML model through a set of initial data;
continuously training the AI or ML model through analyzed data collected from a plurality of users;
updating the set of parameters for the AI or ML model based on the analyzed data from a plurality of users; and
obtaining a higher threat score precision via the updated set of parameters for the AI or ML model,
wherein the trained AI or ML model is configured to intake the generated match scores and generate the threat score based on an assessment of the generated match scores.

13. The computer program of claim 9, wherein the data transmission device is a smart card device further comprising:
the on-board generative AI;
at least one built in internet of things (IoT) sensor associated with collecting user data comprising a geocoordinate, an internet protocol (IP) address, a device identifier (ID), or a user voice sample;
a digital display which is configured to display a set of relevant data based on a user requested task;
an alert mechanism configured to trigger an audio notification based on an invalidation of the direct user input; and
at least one non-transitory memory device that stores temporary data.

14. The computer program of claim 13, wherein the at least one non-transitory memory device is a cache temporary memory device that is configured to temporarily store a plurality of user authentication data for reuse in an instance of a disruption of a user requested task.

15. A method for enhancing security associated with networked devices via AI enhanced processing, the method comprising:
initiating data collection based on a direct user input into a data transmission device;
authenticating a user based on a data transmission device onboard generative AI analysis of the direct user input compared to at least one previous direct user input;
generating, in response to the authentication, a user dataset from the direct user input and from a plurality of indirect user inputs to the data transmission device;
validating the direct user input based on a threat score of the user dataset if the threat score of the user dataset is above a required threat score threshold or invalidate the direct user input if the threat score of the user dataset is below the required threat score threshold; and
triggering a response from the data transmission device based on the validation or the invalidation of the direct user input.

16. The method of claim 15, wherein the user dataset is transferred to an orchestration engine configured to:
receive the user dataset from the data transmission device;
request and aggregate a plurality of stored user data from a plurality of data storage locations, wherein the plurality of stored user data comprises previous direct user inputs and indirect user inputs;
configure the user dataset and the plurality of stored user data for analysis in a threat analytics module;
prioritize a data element from the user dataset and a data element from the plurality of stored user data to be output;
transfer the data elements to a threat analytics module; and
repeat the prioritization and transfer for a plurality of subsequent data elements.

17. The method of claim 16, wherein the threat analytics module is a cloud-based natural language application programming interface (API) for threat analytics configured to:
receive an input of data from the orchestration engine;
compare similar data elements from the user dataset and the plurality of stored user data;
generate a match score between the compared similar data elements; and
transfer the generated match scores to an AI or ML model.

18. The method of claim 17, wherein the AI or ML model is continuously trained through a federated learning strategy comprising:
initializing a set of parameters for the AI or ML model through a set of initial data;
continuously training the AI or ML model through analyzed data collected from a plurality of users;
updating the set of parameters for the AI or ML model based on the analyzed data from a plurality of users; and
obtaining a higher threat score precision via the updated set of parameters for the AI or ML model,
wherein the trained AI or ML model is configured to intake the generated match scores and generate the threat score based on an assessment of the generated match scores.

19. The method of claim 15, wherein the data transmission device is a smart card device further comprising:
the on-board generative AI;
at least one built in internet of things (IoT) sensor associated with collecting user data comprising a geocoordinate, an internet protocol (IP) address, a device identifier (ID), or a user voice sample;
a digital display which is configured to display a set of relevant data based on a user requested task;
an alert mechanism configured to trigger an audio notification based on an invalidation of the direct user input; and
at least one non-transitory memory device that stores temporary data.

20. The method of claim 19, wherein the at least one non-transitory memory device is a cache temporary memory device that is configured to temporarily store a plurality of user authentication data for reuse in an instance of a disruption of a user requested task.
